(19) United States
(12) Patent Application Publication
(10) Pub. No.: US 2003/0145665 A1
(43) Pub. Date: Aug. 7, 2003

(54) Land mine probe

(75) Inventor: Ronald J. Robley, Beaverton, OR (US)

Correspondence Address: FOLEY & LARDNER, 777 EAST WISCONSIN AVENUE, SUITE 3800, MILWAUKEE, WI, 53202-5308, US

(73) Assignee: Alterra Holdings Corporation

(21) Appl. No.: 10/355,631

(22) Filed: Jan. 31, 2003

Related U.S. Application Data
(60) Provisional application No. 60/353,137, filed on Feb. 1, 2002.

(51) Int. Cl. G01D 21/00

(52) U.S. Cl. 73/866.5

(57) ABSTRACT

A land mine probe includes a handle and a first shaft extending from the handle and terminating at a tip. In one embodiment, the probe includes a second shaft extending from the handle and terminating at a second tip. In another embodiment, the shaft includes a plurality of segments releasably attached to one another and releasably attached to the handle. In yet another embodiment, the probe includes a sound amplification device. In still another embodiment, the probe includes a device for emitting light in a direction towards the tip.

### CROSS-REFERENCE TO RELATED PATENT APPLICATIONS

The present application claims priority under 35 U.S.C. §1.19 from U.S. Provisional Patent Application Serial No. 60/353,137 filed on Feb. 1, 2002 and entitled LAND MINE PROBE, the full disclosure of which is hereby incorporated by reference.

### FIELD OF THE INVENTION

The present invention relates to devices for sensing or detecting land mines. In particular, the present invention relates to a land mine probe.

### BACKGROUND OF THE INVENTION

Mine probes are used to detect the presence of land mines buried a few inches beneath the surface of the ground. Conventional land mine probes use a number of methods to detect the location of land mines, including the use of acoustical sensors, force sensors, and mechanical probes.

Although many advances have been made in mine detecting devices, the most reliable method for detecting buried mines is still the use of a mechanical probe. Such probes typically consist of an elongate shaft or rod which terminates at a pointed tip. Since mines are sensitive to both electric and magnetic fields, and since land mines typically sense the presence of magnetic materials, such probes are typically formed from non-magnetic material. One common material used is titanium due to its light weight and high strength. The strength of titanium facilitates insertion of the tip into rocky soils. However, in environments where static levels are high, such as in sandy soils, the alternative use of mechanical probes having polymeric or plastic tips is preferred to prevent or minimize the possibility of the creation of sparks.

Unfortunately, when in the field using a mine probe, a soldier utilizing the device must concentrate at the task at hand and not be burdened with carrying extra equipment. Accordingly, the soldier does not wish to carry several full length mine probes to permit the use of different or sharpened tips when necessary. Thus, there remains a need for a mine probe that is light weight, that is easy to carry in the field and that is adaptable for use in different environments.

### SUMMARY OF THE INVENTION

According to one aspect of the present invention, a land mine probe includes a handle, a first shaft extending from the handle and terminating at a first tip and a second shaft extending from the handle and terminating at a second tip.

According to another aspect of the present invention, a land mine probe includes a handle, a shaft extending from the handle and terminating at a tip and a sound amplification system coupled to the shaft.

According to yet another aspect of the present invention, a land mine probe includes a handle, a shaft extending from the handle and terminating at a tip and a light emitting device configured to emit light in a direction towards the tip.

According to yet another aspect of the present invention, a method for detecting underground land mines includes the steps of inserting a tip of a shaft into the ground until an obstruction is struck by the tip, emitting a light in a direction towards the tip and observing a reflection of the light.

According to yet another aspect of the present invention, a method for detecting an underground land mine includes the steps of inserting a tip of a shaft into the ground until an obstruction is struck by the tip, amplifying a sound transmitted through the shaft as a result of the tip striking the obstruction and listening to the amplified sound to identify land mines based on the amplified sound.

According to yet another aspect of the present invention, a land mine probe includes a handle, a plurality of main segments releasably coupled to one another and releasably coupled to the handle and a tip segment releasably coupled to one of the plurality of main segments.

### BRIEF DESCRIPTION OF THE DRAWINGS

FIG. 1 is a top plan view of a land mine probe in a first configuration.

FIG. 2 is a top plan view of the land mine probe in a second configuration.

FIG. 3 is an enlarged fragmentary sectional view of the probe of FIG. 1 illustrating a handle of the probe in greater detail.

FIG. 4 is an enlarged fragmentary sectional view illustrating portions of a shaft of the probe of FIG. 1 in greater detail.

FIG. 5 is a top plan view of a first tip segment of the probe of FIG. 1.

FIG. 6 is a top plan view of a second tip segment of the probe of FIG. 1.

FIG. 7 is an enlarged fragmentary sectional view of a portion of a first alternative embodiment of the probe shown in FIGS. 1-6.

FIG. 8 is an end elevational view of the probe shown in FIG. 7 shown along line 8-8 of FIG. 7.

FIG. 9 is a top plan view of a second alternative embodiment of the probe shown in FIGS. 1-6.

### DETAILED DESCRIPTION OF THE PREFERRED EMBODIMENTS

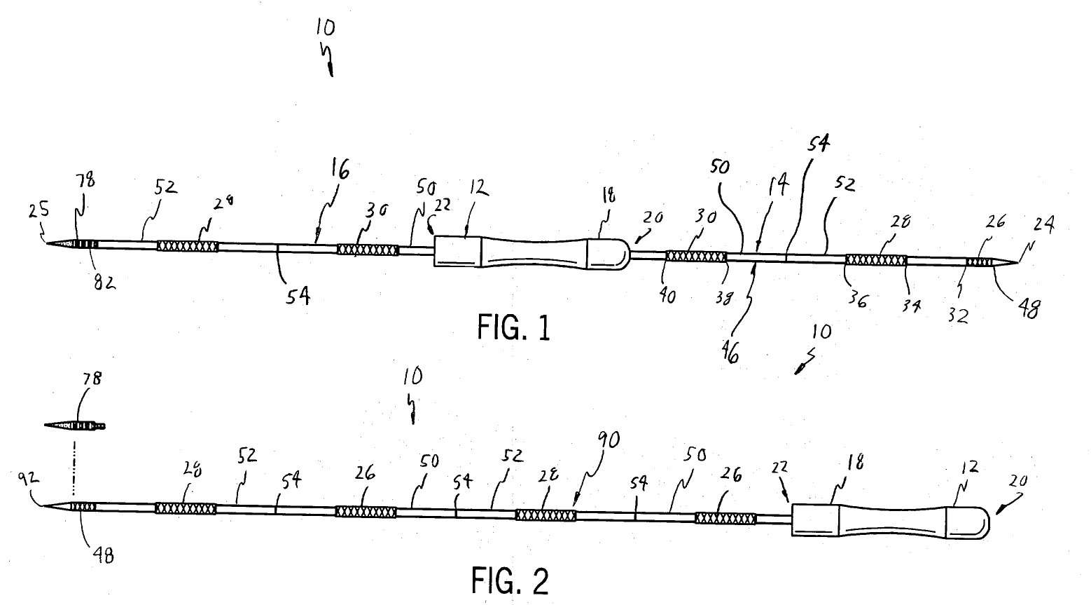

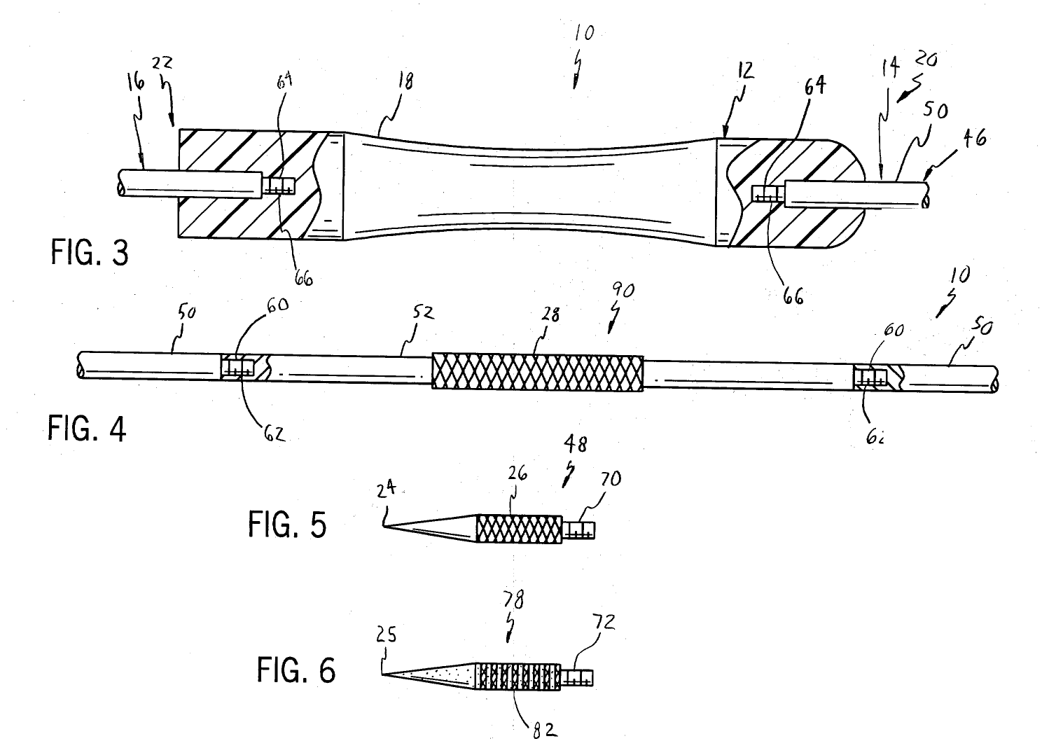

FIG. 1 illustrates a land mine probe 10 for use in detecting underground land mines. Probe 10 generally includes handle 12, shaft 14 and shaft 16. Handle 12 generally comprises a structure configured for being grasped by the user of probe 10. As best shown by FIG. 3, handle 12 has an exterior surface 18 against which handle 12 is contacted by the user's hand. Surface 18 has a non-uniform surface characteristic. In particular, surface 18 has a non-uniform surface contour. For example, portions of surface 18 adjacent to end 20 of handle 12 have a rounded, bulbous axial face, while portions of surface 18 proximate to end 22 of handle 12 have a squared off axial face so as to provide a distinct, sharper shoulder. In the embodiment shown, the axial faces of handle 12 proximate ends 20 and 22 have a generally circular cross section. In alternative embodiments, one or both of the axial faces may have other shapes such as rectangular, octagonal and the like to accommodate different gripping preferences. Although handle 18 is illustrated as being generally cylindrical in shape, handle 18 may have a variety of alternative shapes and configurations to improve grasping of handle 12.

Handle 12 is preferably formed from an electrically nonconductive plastic having high strength, such as high-impact polyacetal resin sold by E. I. DuPont De Nemours, under the trade name of DELRIN. Alternatively, wood, fiberglass or other polymeric or plastic materials may be employed for handle 12 such that handle 12 is not electrically conductive and is not magnetic.

In the particular embodiment shown, handle 12 has an axial length of approximately 6.5 inches and a diameter of approximately 1.0 inches. It has been found that this configuration of handle 12 is of sufficient length so as to be comfortably grasped by the hand of all users. At the same time, handle 12 is sufficiently short so as to not result in probe 12 having a cumbersome length making transport of probe 10 difficult.

Although handle 12 is illustrated and described as being integrally formed from a homogenous single material, handle 12 may alternatively be formed from different materials or a plurality of components permanently or releasably coupled to one another. For example, in one embodiment, handle 12 may include a hollow interior configured for the reception of tip segments, main segments or other tools or supplies described hereafter. In one embodiment, one end of handle 12 may be configured as a cap to be releasably coupled to the remainder of handle 12 by threading and the like. In such an application, the hollow interior of handle 12 would preferably be configured to hold a plurality of tip segments. In still other embodiments, handle 12 may include an exterior surface, at least portions of which, are configured with a layer of soft compressible materials, such as SANTOPRENE, foam, rubber and the like, to facilitate improved gripping.

Shaft 14 extends from handle 12 and terminates at a point or tip 24. Tip 24 is configured to be prodded or inserted into the ground to detect a land mine. In the particular embodiments illustrated, shaft 14 preferably has a length extending beyond handle 12 of at least about 12 inches. In the particular embodiment illustrated, shaft 14 has such a length of approximately 13 inches. Shaft 14 is preferably formed from a material and has a sufficient diameter or thickness such that shaft 14 is not overly heavy and such that shaft 14 has sufficient stiffness so as to maintain its shape when being inserted into the ground and when encountering obstructions. During use of probe 10, it is important that the operator or user know a distance of tip 24 from handle 12. Shaft 14 is preferably stiff so as to minimize or eliminate substantial deflection of shaft 14 when encountering an obstruction. In the particular embodiments illustrated, shaft 14 is formed from titanium and has a thickness of between about 0.2 inches and 0.5 inches. Preferably, shaft 14 has a thickness of approximately 0.25 inches.

As further shown by FIG. 1, shaft 14 is further provided with a plurality of indicia 26, 28, 30 indicating a distance from a terminal point or tip 24 of shaft 14. Upper end 32 of indicia 26 is approximately 1.75 inches from tip 24. The end 34 of indicia 28 is approximately 3.75 inches from tip 24. The end 36 of indicia 28 is approximately 5.75 inches from tip 24. The end 38 of indicia 30 is approximately 9.75 inches from tip 24. The end 40 of indicia 30 is approximately 11.75 inches from tip 24.

In the particular embodiment illustrated, indicia 26, 28 and 30 each comprise roughened portions along the exterior surface of shaft 14. In the particular embodiments illustrated, such roughened portions comprise knurls which have an outer diameter of approximately 0.26 inches. In other embodiments, rubber, SANTOPRENE sold by Advanced Elastomers (a thermoplastic elastomer which is polypropylene based with dispersed vulcanized rubber in it), elastomeric foam or other compressible grippable sleeves or tubes may be formed or attached to the exterior of shaft 14 to facilitate gripping of the portions of shaft 14. Alternatively, indicia 26, 28 and 30 may be smooth or may be provided with alpha-numeric symbols such as numbers or marks indicating precisely distances from tip 24.

As further shown by FIG. 1, shaft 14 generally includes a main portion 46 and a tip segment 48. Main portion 46 generally includes a plurality of main portion segments 50, 52 releasably coupled to one another along junction 54. For purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Junction 54 is equidistantly spaced from ends 36 and 38 of indicia 28, 30. In the particular embodiment illustrated, junction 54 is spaced from ends 36 and 38 by approximately 2 inches. As a result, junction 54 provides an additional indicia for identifying distance from tip 24. Junction 54 is approximately 7.75 inches from tip 24. In the particular embodiments illustrated, segments 50 and 52 are releasably attached to one another by an internal bore or pocket 60 (shown in FIG. 4), and an externally threaded rod or plug 62 on the other of segment 50, 52. Alternatively, other mechanisms may be employed to releasably secure segments 50 and 52 to one another such as snap fit mechanisms, bayonet type attachment mechanisms and the like.

As shown by FIG. 3, one end of segment 50 includes an externally threaded plug 64 which is threadably received within internally threaded bore 66 provided in handle 12 to releasably attach main portion 46 and segment 50 to handle 12. Alternatively, other mechanisms may be employed to releasably attach segment 50 and main portion 46 to handle 12. In other alternative embodiments, segment 50 may be permanently attached to handle 12.

Tip segment 48 is best shown in FIG. 5, tip segment 48, like segments 28 and 30, are formed entirely from nonmagnetic metallic material such as titanium. As shown by FIG. 5, tip segment 48 is also configured to be releasably attached to main portion 46 and, in particular, segment 52. To this end, tip segment 48 includes an externally threaded plug 70 configured to threadably engage an internally threaded bore 60 of segment 52. Alternatively, other structures and methods may be utilized to releasably attach segment 26 to main portion 46. Because tip segment 24 is formed entirely from titanium, tip 26 has increased durability and stiffness, and remaining lightweight. Although tip segment 48 is preferably formed entirely from titanium, tip segment 48 may alternatively be formed from alloys, composites, or may be formed from different materials, wherein the outer surface of tip segment 48 has a layer of titanium material.

As shown by FIG. 1, shaft 16 is substantially identical to shaft 14 in all respects except that shaft 16 includes tip segment 78 in lieu of tip segment 48. For ease of illustration, those remaining components of shaft 16 which are identical to shaft 14 are numbered similarly. Tip segment 78 is releasably attached to segment 50 of shaft 16 and provides tip 25. As best shown by FIG. 6, tip segment 78 includes an externally threaded rod, pin or plug 72 configured to be threadably received within a corresponding internally threaded bore 60 of segment 52. Unlike tip segment 48, tip segment 78 includes a polymeric material that is electrically non-conductive or electrically insulating. In the particular embodiments illustrated, segment 78 is formed entirely from a polymeric material. Alternatively, tip segment 78 may include an outer surface including a layer of one or more polymeric materials. In the particular embodiment illustrated, tip segment 78 is entirely formed from plastic such as DELRIN. Because tip segment 78 is formed from a polymeric material which is electrically nonconductive, tip segment 78 is best suited for use in environments having high static situations or in environments where underground electrically charged obstructions may be encountered. Thus, under the circumstance, tip segment prevents an electrical charge from being transmitted to the operator or to the user of probe 10.

As further shown by FIG. 6, tip segment 78 includes knurling 82 along at least a portion of the exterior surface. Knurling 82 functions to provide improved gripping to tip segment 78, to serve as an indicia for identifying a distance from tip segment and to assist in visually distinguishing tip 78 from tip 48. In particular, knurling 82 has a distinct knurling pattern as compared to the knurling pattern of indicia 26.

Tip segment 78 has an axial length substantially identical to the axial length of tip segment 48. As a result, shaft 16 has a substantially identical length as compared to shaft 14. In alternative applications, shafts 14 and 16 may have differing lengths.

Overall, probe 10 provides a single land mine detecting probe that is adaptable for use in different environments. In particular, in circumstances where the ground is rocky or wherein high durability is preferred, a user may use shaft 14 with tip segment 48. Alternatively, where the environment has high static levels or wherein the possibility of encountering an electrically charged underground obstruction is high, the user may alternatively use shaft 16 with tip segment 78 by simply changing his or her grip by repositioning probe 10. Probe 10 is adaptable to such different conditions without requiring the user to exchange tip segments 48 or 78.

Moreover, probe 10 provides still additional advantages even when tip segments 26 and 28 are substantially identical to one another. For example, in circumstances where time is of the essence, and wherein one of the tip segments has worn to a point where it requires sharpening or replacement, the user can simply employ the other shaft with the other tip segment to continue his or her detection of mines. Again, the user does not need to take the time to remove and replace an existing tip with a pre-sharpened tip or to sharpen the worn tip itself.

In still other circumstances, probe 10 enables a user to more comfortably grip and manipulate probe 10. Different users of probe 10 may have different gripping preferences. Because handle 12 has a non-uniform surface characteristic, such as a non-uniform surface contour shape or different surface portions with different feels provided by hard materials or compressible materials, the user of probe 10 may obtain a different hand posture or grip by switching between the use of shafts 14 or 16. The ability of the user to vary his or her hand posture or gripping of handle 12 by switching between shafts 14 and 16 further reduces fatigue of the user's hands after prolonged use of probe 10.

Despite providing the user with two shafts having distinct characteristics or providing the user with the ability to change his or her grip of probe 10 during its use, probe 10 has a weight no greater than 0.4 pounds. With regard to military equipment, the motto is generally “smaller, lighter and quicker.” The weight of military equipment being carried by military personnel is a critical factor in the ability of military personnel to quickly respond to changing circumstances. Because probe 10 is lightweight (nominally 0.395 pounds), probe 10 is well adapted for use in the military.

As discussed above, shafts 14 and 16 are each preferably formed from a plurality of segments releasably attached to one another and releasably attached to handle 12. As a result, probe 10 may be easily broken down into a compact assemblage of components and can be easily carried in a pouch. Main segments 50 and 52 each generally have a length (nominally 6 inches) less than the length (nominally 6.5 inches) of handle 12. As a result, the maximum length of the broken down assemblage including handle and components is no greater than 6.5 inches. Although less desirable, main portions 46 of shafts 14 and 16 may alternatively be formed from a single segment that is permanently coupled to handle 12 or that is releasably attached to handle 12. Although less desirable, in still other alternative embodiments, shafts 14 and 16 may alternatively be formed from a single shaft member permanently coupled to handle 12 or releasably attached to handle 12.

In the particular embodiment illustrated, segments 50 and 52 of shaft 16 are configured to be releasably coupled between segments 50 and 52 of shaft 14. In one embodiment, segments 50 and 52 of both shafts 14 and 16 are completely interchangeable with one another and releasably attachable to one another. Preferably, segments 48 and 70 are also interchangeable with one another. As a result, probe 10 may be quickly and easily reconfigurable to a user in the field wherein one of a plurality of different lengths having a desired tip segment 48 or 78. For example, FIG. 2 illustrates probe 10 reconfigured with all of segments 50, 52 releasably attached to one another and extending from one point of handle 12. A detailed view of the interconnection of segments 50 and 52 is shown in FIG. 4. The resulting probe 10 has a reconfigured shaft 90 having a length extending from handle 12 to tip 92 of approximately 25 inches. By removing one of segments 50, 52 (which have identical lengths), the length of shaft 90 will be reduced to approximately 19 inches. In such a reconfigured probe 10, the ends of indicia 26, 28 and junctions 54 indicate the extent to which shaft 90 is inserted into the ground. Generally, each of segments 50 and 52 has a total axial length of 6 inches including a length of 2 inches on each side of each indicia 26, 28 which also have a length of 2 inches. Although not illustrated, additional segments 50, 52 may be added to further increase the length of shaft 90. In this way, probe 10 may be adjusted to meet the preferences of the user deploying probe 10. Similarly, as noted above, tip segment 48 may be replaced with tip segment 78 depending upon the environment in which probe 10 is being used. Although less desirable, probe 10 may alternatively be configured to enable segments 50, 52 to be only releasably attached to handle 12 from a single point of handle 12, rather than from opposite ends of handle 12.

With respect to the configuration shown in FIG. 2, the unused tip segment may, in some embodiments, be configured to be threadably secured within the internally threaded bore at the unused end of handle 12.

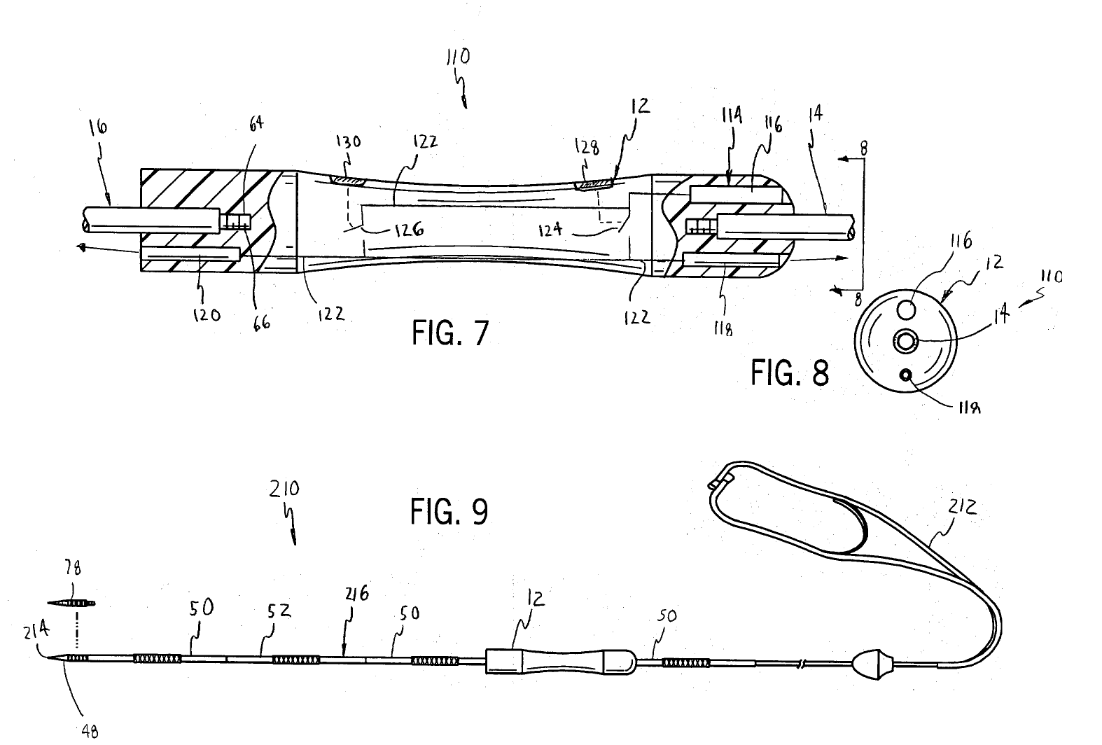

FIG. 7 illustrates land mine probe 110, an alternative embodiment of land mine probe 10 shown in FIGS. 1-6. Probe 110 is similar to probe 10 except that probe 10 additionally includes light emission system 114. For ease of illustration, those remaining components of probe 110 which correspond to components of probe 10 are numbered similarly.

Light emission system 114, schematically shown in FIG. 7, generally includes power source 116 and light generators 118, 120. Power source 116 comprises a structure or mechanism configured to supply power to generators 118 and 120. Power source 116 is electrically coupled to generators 118, 120 by electrical circuit or electrical wiring 122 including switches 124 and 126. Switches 124 and 126 are coupled to actuators 128 and 130, respectively, so as to move between a closed power conducting state and an open non-power conducting state in response to depressment of actuation switches or buttons 128 and 130 located on the surface of handle 12. Actuators 128 and 130 may comprise conventionally known slides, buttons or push buttons such as commonly employed on flashlights. Depressment of actuators 128 and 130 enables the user to selectively power one or both of generators 118, 120 from source 116.

In one embodiment, source 116 comprises a battery removably disposed within an interior cavity of handle 12. Power source 116 is preferably enclosed and sealed within housing 12 by a cap or other sealing structure. Although less desirable, electrical wire 122 may alternatively be configured to continuously supply power to both generators 118 and 120. In some embodiments, handle 12 may be provided with only a single light generator.

Light generators 118 and 120 are substantially identical to one another. Generator 118 is configured to emit a light along an axis of shaft 14. Generator 120 is configured to emit a light along the axis of shaft 16. Light emitted by generators 118 and 120 is preferably directed or aimed at or at least towards tips 24 and 25 of shafts 14 and 16, respectively. In the particular embodiment illustrated, generators 118 and 120 are preferably configured to emit a laser light in the direction towards the tips of shafts 14 and 16. Laser light is preferably emitted at an angle so as to cross the tip or a point proximate to the tip of each of shafts 14 and 16.

In the most preferred embodiment, the laser light is in the green spectrum which provides maximum visibility. It has been discovered that upon striking metal, such as that of a land mine, a brilliant reflection will result which is easily and more quickly detectable by visual observation. As the light emitted by either generator 118 or 120 preferably comprises a laser, the light may additionally be used to illuminate and identify trip wires and may also be used for communication such as signaling a rescue party. Improved results are achieved by utilizing a green laser.

In one embodiment, each of generators 118 and 120 comprise laser generators of conventional construction including a mixed gas or diode laser. The generator produces a rotating, oscillating or refractive laser. Examples of the type of laser generator comprising generators 118 and 120 are disclosed in U.S. Pat. No. 6,007,219 entitled LASER LIGHTING SYSTEM which issued on Dec. 28, 1999, the full disclosure of which is hereby incorporated by reference. Although less desirable, generators 118 and 120 may alternatively be configured to emit light in a fashion similar to that of a flashlight. This light facilitates identification of the obstruction struck by probe 110.

FIG. 9 illustrates land mine probe 210, a second alternative embodiment of probe 10 shown in FIGS. 1-6. Probe 210 is similar to probe 10 except that probe 210 additionally includes sound amplification system 212. For ease of illustration for those remaining components of system 210 which correspond to identical components of system 10 are numbered similarly. Sound amplification system 212 comprises a structure releasably coupled to segment 50 configured to receive and amplify sound transmitted from tip 214 along shaft 216 through handle 12 and through segment 50 adjacent to system 212. System 212 supplies such sound to enable the user of probe 210 to distinguish between different sound characteristics to identify whether the obstruction is metal, wood or plastic (which have different sound characteristics upon being struck). As a result, probe 210 facilitates easier identification of the type of land mine to enable military personnel to determine the best approach to disarm the land mine.

In the particular embodiment illustrated, sound amplification system 212 includes a conventionally known stethoscope having an end threadably coupled to the adjacent segment 50. In lieu of being attached to the adjacent segment 50, system 212 may alternatively be directly attached to handle 12 in either a permanent or releasable fashion. In other embodiments, probe 210 may additionally be provided with a metal outer shaft passing through handle 12 and connected to shaft 216 and system 212 to provide improved sensitivity and sound transmission. In further alternative embodiments, system 212 may alternatively be configured to be releasably or permanently clamped to shaft 216 between handle 12 and tip 214.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the following claims is manifestly intended to be as broad as possible. For example, unless specifically otherwise noted, the claims reciting a single particular element also encompass a plurality of such particular elements.

What is claimed is:

1. A land mine probe comprising:
a handle;
a first shaft extending from the handle and terminating at a first tip; and
a second shaft extending from the handle and terminating at a second tip.

2. The probe of claim 1, wherein the handle has a non-uniform surface characteristic.

3. The probe of claim 2, wherein the handle has a non-uniform surface contour.

4. The probe of claim 1, wherein the first shaft has a first characteristic and wherein the second shaft has a second characteristic different than the first characteristic.

5. The probe of claim 1, wherein the first tip has a first characteristic and wherein the second tip has a second characteristic different than the first characteristic.

6. The probe of claim 5, wherein the first tip includes an electrically non-conductive material and wherein the second tip includes an electrically conductive material.

7. The probe of claim 6, wherein the first tip includes a polymeric material and wherein the second tip includes a non-magnetic metallic material.

8. The probe of claim 5, wherein the first tip includes a polymeric outer surface and wherein the second tip includes a nonmagnetic metallic outer surface.

9. The probe of claim 8, wherein the first tip is formed entirely from a polymeric material and wherein the second tip is formed entirely from a non-magnetic metallic material.

10. The probe of claim 1, wherein the first shaft includes a plurality of indicia indicating a distance from a terminal point of the first tip.

11. The probe of claim 10, wherein the plurality of indicia are equally spaced along the first shaft.

12. The probe of claim 10, wherein the plurality of indicia comprise roughened portions spaced along the first shaft.

13. The probe of claim 12, wherein the roughened portions comprise knurls.

14. The probe of claim 1, wherein the first shaft includes a first main portion extending from the first end of the handle and a first tip segment providing the first tip, wherein the first tip segment is removably attached to the first main portion.

15. The probe of claim 14, wherein the second shaft includes a second main portion extending from the second end of the handle and a second tip segment providing the second tip, wherein the second tip segment is removably attached to the second main portion.

16. The probe of claim 15, wherein the second tip segment is configured to be removably attached to the first main portion.

17. The probe of claim 15, wherein the first tip segment includes an electrically non-conductive outer surface and wherein the second tip segment includes a non-magnetic metallic outer surface.

18. The probe of claim 14, wherein the first main portion includes a plurality of first main segments removably attached to one another.

19. The probe of claim 18, wherein one of the plurality of first main segments is removably attached to the first end of the handle.

20. The probe of claim 18, wherein the second shaft includes a second main portion extending from the handle and a second tip segment providing the second tip, wherein the second tip segment is removably attached to the second main portion.

21. The probe of claim 20, wherein the second tip segment is configured to be releasably attached to at least one of the plurality of first main segments.

22. The probe of claim 20, wherein the second main portion includes a plurality of second main segments removably attached to one another.

23. The probe of claim 22, wherein one of the plurality of second main segments is removably attached to the second end of the handle.

24. The probe of claim 23, wherein the plurality of first main segments are interchangeable with the plurality of second main segments.

25. The probe of claim 20, wherein the plurality of first main segments are interchangeable with the plurality of second main segments.

26. The probe of claim 20, wherein the handle has a first length and wherein the first main segments and the second main segments have individual lengths no greater than the first length.

27. The probe of claim 26, wherein the first main segments and the second main segments have individual lengths no greater than one inch less than the first length.

28. The probe of claim 20, wherein the plurality of second main segments are configured to be releasably attached to and between a first one of the plurality of first main segments and a second one of the plurality of first main segments.

29. A land mine probe comprising:
a handle;
a shaft extending from the handle and terminating at a tip; and
a sound amplification system coupled to the shaft.

30. The probe of claim 29, wherein the sound amplification system is coupled to the handle.

31. The probe of claim 30, wherein the sound amplification system is releasably coupled to the handle.

32. The probe of claim 29, wherein the sound amplification system includes a stethoscope.

33. A land mine probe comprising:
a handle;
a shaft extending from the handle along an axis and terminating at a tip; and
a light emitting device configured to emit light in a direction towards the tip.

34. The probe of claim 33, wherein the light emitting device is supported by the handle.

35. The probe of claim 33, wherein the light emitting device is configured to emit a light along the axis.

36. The probe of claim 35, wherein the light emitting device is configured to emit a light substantially parallel to the axis.

37. The probe of claim 33, wherein the light emitting device is configured to emit a laser towards the tip.

38. The probe of claim 37, wherein the laser is green.

39. The probe of claim 33 including a switch for actuating the light emitting device.

40. A method for detecting underground land mines, the method comprising:
inserting a tip of a shaft into the ground until an obstruction is struck;
emitting a light towards the tip; and
observing a reflection of the light.

41. A method for detecting underground land mines, the method comprising:
inserting a tip of a shaft into the ground until an obstruction is struck;
amplifying a sound transmitted through the shaft as the result of striking the obstruction with the tip; and
listening to the amplified sound to determine whether the obstruction is a land mine based on the amplified sound.

42. A land mine probe comprising:
a handle;
a plurality of main segments releasably attached to one another and releasably attached to the handle; and
a tip segment releasably coupled to one of the plurality of main segments.
